(19) United States
(12) Patent Application Publication
(10) Pub. No.: US 2001/0034697 A1
(43) Pub. Date: Oct. 25, 2001

(54) Integrated auction system

(76) Inventor: Hooshang Kaen, La-Jolla, CA (US)

Correspondence Address: Joseph P. Kincart, Clifford Chance Rogers & Wells LLP, 200 Park Avenue, New York, NY, 10166, US

(21) Appl. No.: 09/836,909

(22) Filed: Apr. 17, 2001

Related U.S. Application Data
(60) Provisional application No. 60/199,556, filed on Apr. 25, 2000.

(51) Int. Cl. G06F 17/60

(52) U.S. Cl. 705/37

(57) ABSTRACT

A method and system for participating in a live auction via a computer communications system. Computer servers are utilized to transmit real time images of a live auction and track bids presented for particular properties being auctioned. Highest bids are processed such that they are integrated into the live auction. Software routines direct bids on a particular piece of property to an appropriate live auction and escalate responsive actions according to the circumstances of the auction. A description of a piece of property to be auctioned and a real time video image of a scene depicting a live auction of the property are transmitted over a computer communications network. A bid for the property is received and notification of a winning bid can be transmitted via the computer communications network. In addition to the description of the property, which can be textual or a graphic image, a video image of the property providing various views and details can also be transmitted. Real time video images depict live scenes of the auction.

### BACKGROUND

This invention relates to a method and system for augmenting an auction process. In particular, the present invention relates to expanding live auction participation through the use of an electronics communications network.

Auctions pertain to the purchase or sale of real or personal property through a public bidding process. Traditionally, auctions consisted of the gathering together of interested parties, wherein the parties would form a crowd and make a succession of increasing bids for a particular piece of property being auctioned. An auctioneer, acting as an agent for the seller, would facilitate the auction, generally motivating potential buyers to make increasing bids. The enthusiasm of the crowd and the momentum sustained by the auctioneer was generally designed to secure a satisfactory price for the property sold. The momentum of the auction is carried until the auctioneer accepts a highest final bid. Conversely, a despondent crowd generally has a dampening effect on offers being made, wherein a lack of enthusiasm by other bidders can act as a warning to a potential bidder concerning a possible defect in the property being sold.

An auction process can begin with a listing of the particular pieces of property that will be included in the auction. Assessment of a piece of property typically transpires prior to the live auction process. Potential buyers are given the opportunity to make a first hand inspection and/or commission a professional appraisal of the property subsequently auctioned. Simultaneous inspection of auctioned property by multiple potential bidders can set a mood pertaining to a particular piece of property. The mood surrounding a piece of property can be influential in determining the interest shown by bidders during the bidding process. Many bidders at a live auction will carefully observe the actions of other bidders and use this observance to determine a best course of action for themselves.

In addition to the bidding crowd, a traditional bidding institution can add credibility to an auction. Property offered for sale by an established auction house carries with it the credibility factor of the previous sales conducted by the auction house. For example, Christie, Manson & Woods Ltd. of London set two sales records in one year, a Van Gogh painting sold for $82.5 million and the Badminton Cabinet sold for $15.2 million. Similarly, Sotheby's Holdings Inc. has sold, at auction, a Rembrandt painting for $2.3 million. Auctions of this magnitude rely on the professional interaction of the bidding crowd and the auctioneer to generate that kind of record breaking interest.

Computer networks, and the Internet in particular, have created a resurgence in the use of auctions as a means of conducting commerce. Generally the Internet makes an auction available to a larger audience than a local auction can accommodate. In addition, the Internet can be useful in allowing a bidder to participate who may be otherwise constrained due to geographical limitations. Typically a picture and/or description of a piece of property is made available to potential bidders via a Website on the Internet. Based on the description, bidders can make a bid for the property. A cutoff date and time ends all bidding. A bidder with the highest offer is awarded the item at the highest bid price. Payment for a winning bid can either be arranged between the two parties, or through an auction service conducting the auction.

Internet auctions have popularized various formats for auctions for almost any conceivable property. For example, Dutch auctions are offered on the Internet wherein a seller offers property at successively lower prices until one of his offers is accepted. Reverse auctions operate wherein several sellers compete to sell an equivalent product at successively lower prices. A Vickery auction awards the auctioned item to the highest bidder at the sum bid by the second highest bidder. Another variation allows a buyer to name a price the buyer is willing to pay for a product or service and various sellers can accept the offer. However, none of the present forms of auctioning conducted on the Internet makes available the ability to incorporate the emotions of the bidding crowd and the enthusiasm surrounding the bidding process.

### SUMMARY

Accordingly the present invention provides a method and system for participating in a live auction via a computer communications system. Computer servers can be utilized to transmit real time images of a live auction and track bids presented for particular properties. The system can process highest bids such that they are integrated into a live auction. Software routines can direct bids on a particular piece of property to an appropriate live auction and escalate responsive actions according to the circumstances of the auction.

In one embodiment the invention includes a computer-implemented method for providing online participation in a live auction. The method involves transmitting over a computer communications network a description of a piece of property to be auctioned and a real time video image of a scene depicting a live auction of the property. A bid for the property can also be received via the computer communications network and a notification of a winning bid can be transmitted. In addition to the description of the property, which can be textual or a graphic image, a video image of the property providing various views and details can also be transmitted. Real time video images can also depict live scenes of the auction.

One aspect of the invention includes calculating a highest bid received for a particular property and presenting the highest bid to an auctioneer involved in auctioning the property. Presentation of the highest bid to the auctioneer can be accomplished, for example, with an electronic display or via a surrogate bidder in the bidding crowd. The financial credibility of a bidder submitting a bid can be verified before presentation to the auctioneer.

Multiple auctions with corresponding images and bids can also be tracked wherein a bid is received for a particular property and transmitted to a corresponding auction house server.

This invention may be embodied in a computer communications system, which provides online participation in a live auction. The system can include a computer server accessible via a computer communications network and a multimedia device, such as, for example, a video camera, capable of inputting scenes from the live auction into the server. Executable software residing in a server memory can be operative with a processor to transmit scenes input from the multimedia device over the communications network. The server can also receive bids and transmit a notification relating a winning bid via the communications network.

In another embodiment, the software can be executable on demand via a network access device, such as a computer. For example, a computer accessing the Internet or other communication network conforming to the transmission control protocol/internet protocol, such as an intranet, can use a WEB interface for accessing the executable software stored on a server storage medium.

The computer communications system can also be used to manage online participation in multiple live auctions. A system for multiple live auctions can include an auction host server and one or more auction house servers. Each server will typically include a memory, a processor and an input device. The auction house server will be connected to a multimedia device capable of inputting a scene from a live auction into the auction house computer server.

Executable software residing in the server memory can be operative with the corresponding processor to cause a scene input by the multimedia device to be transmitted over the communications network. In different embodiments the auction host server or the auction house server may transmit the images. Similarly, a server can receive a bid for an auctioned property via the communications network. If the auction host server receives a bid it can subsequently transmit the bid to the auction house server. The software can also be operative to transmit a notification of a winning bid. Notification of a winning bid may include a general announcement signaling the end of the auction and the amount of the winning bid. Notification may also be specifically directed to the winning bidder.

Other embodiments include a computer readable medium or a data stream containing code for effecting the method. The details of one or more embodiments of the invention are set forth in the accompanying drawings and the description below. Implementations can provide advantages such as availing a live auction to participants from different geographic locations. Other features, objects, and advantages of the invention will be apparent from the description, the drawings and the claims.

### DESCRIPTION OF THE DRAWINGS

FIG. 1 illustrates a block diagram of live auction systems interfacing with a live auction host.

FIG. 2 illustrates a Live Auction host interfacing with network access devices.

FIG. 3 illustrates strategic use of live multimedia devices in an online auction setting.

FIG. 4 illustrates a network access device display with separate areas displaying various functions.

FIG. 5 illustrates a flow chart of steps that may be implemented to implement a live auction system.

### DETAILED DESCRIPTION

A Live Auction computer communications system can provide a vehicle to participate in a live auction via a computer communications network. An auction participant uses a network access device, such as a computer, to view auction proceedings and present bids timely to bidding from an auction crowd.

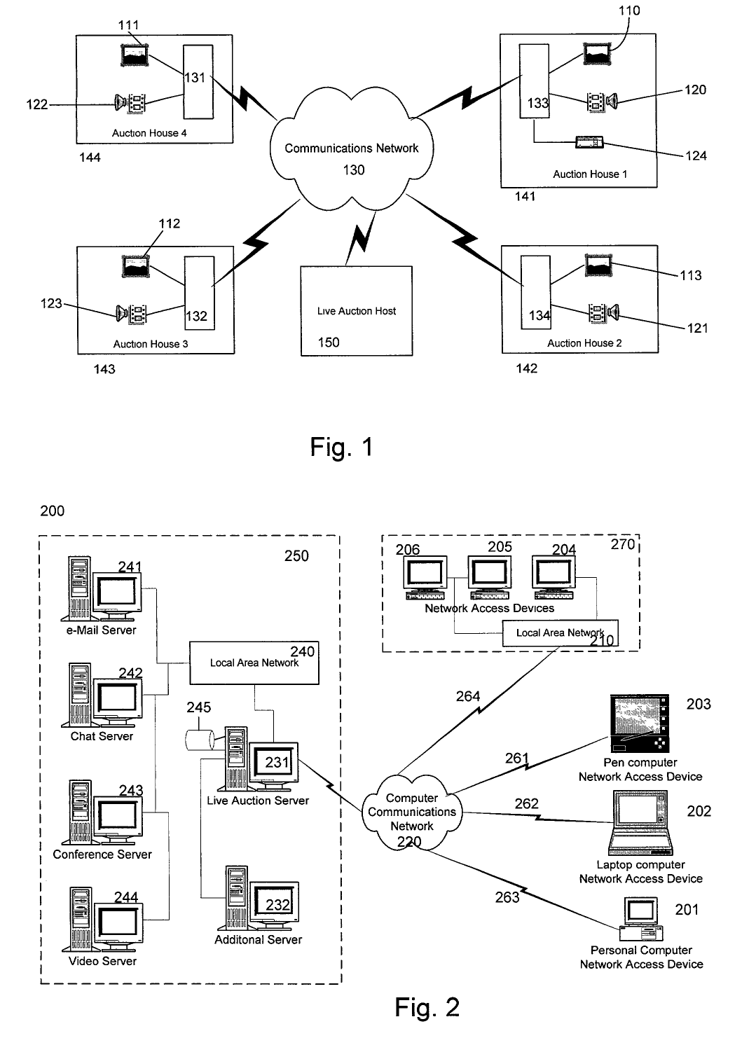

Referring now to FIG. 1, a live online auction communications system can include a processing system 131-134 located at an auction house 141-144. The processing system 131-134 can coordinate inputs which are transmitted over a communications network 130 such as the Internet. The inputs can be transmitted to a live auction host 150. Inputs can include, for example, an image 110-113 of a piece of property which will be auctioned. Inputs can also include live video feeds from a multimedia device 120-123. The multimedia device 120-123 can record various aspects of an auction in real time as the auction progresses. Other inputs can be received from an input device such as a specialized keyboard 124 or other input device 125. Input device 125 can include a joystick, a mouse, a track ball, a touch pad, or any other interface device which allows a user to control a processing system. Typically a person conducting an auction such as an auctioneer will operate the input device.

Inputs from the auction house 141-144 can be scheduled such that the live auction host 150 receives input from the auction house processing system 131-133 only during a live auction, or such that the live auction host 150 receives input from the processing system 131-133 at any time up to and including the time of the auction. Inputs prior to the auction can include, for example, images of the property that will be auctioned, images of the facility at which the auction will take place, descriptions of the property to be auctioned, a history of the auction house, a biography of the auctioneer, or any other information that may be useful to a potential bidder at the live auction.

Inputs from the auction house 141-144 during the live auction can include video and/or images of the bidding crowd, audio of the auctioneer and the bidding crowd, video and/or images of the property being auctioned, a display of the highest current bid, and any other information or images conducive to conducting the live auction. Video can be transmitted via a computer communications network using any known video protocol. Protocols may include, for example, MPEG-4, H.320 standard video, Apple Quicktime™ or Realtime Video™. In general, a low bit video compression algorithm is effective on bandwidths commonly used to access the Internet. However, higher bit algorithms, such as MPEG-1 or MPEG-2 may be desired with networks utilizing a high speed connections. Circuitry can be configured to adapt to the network speed accordingly.

FIG. 2 shows a network of computers 200 that may be used in an implementation of a live on-line auction system. The network 200 can include a host system 250 embodying the live auction host 150 and client computers 201-206 or other network access device. Each of the client computers includes a processor, memory and a user input device, such as a keyboard and/or mouse, and a user output device, such as a display screen and/or printer. The client computers 201-206 can communicate with the host 250 to obtain data stored at the host 250. The client computer 201-206 may interact with the host computer 250 as if the host was a single entity in the network 200. However, the host 250 may include multiple processing and database sub-systems, such as cooperative or redundant processing and/or database servers 241-244, that can be geographically dispersed throughout the network 200. In some implementations, groups of client computers 204-206 may communicate with host 250 through a local area network 210.

The host computer 250 includes one or more databases 245 storing data relating to an auction. Auction data can include the time, date and location of an auction; the auction house, the auctioneer, a list of property to be auctioned, property descriptions and a starting bid. The host 250 may interact with, and gather data from, an auction participant operating a client computer 201-206. Data gathered from the auction participant may be used for qualification of an auction participant. An auction participant can access the host 250 using client software executed at the auction participant's computer 201-206. The client software may include a generic hypertext markup language (HTML) browser, such as Netscape Navigator 4.0 or Microsoft Internet Explorer 5.0, (a “WEB browser”). The client software may also be a proprietary browser, and/or other host access software. In some cases, an executable program, such as a Java™ program, may be downloaded from the host 250 to the client computer and executed at the client computer as part of the live auction software.

The auction content for delivery over the WEB can be developed in conjunction with qualified auction house. An auction house can provide auctioneers, appraisers or other auction house affiliates to act as consultants to develop auction content. In addition the auction houses can create video clips, audio clips, simulations, animated concepts, multimedia presentations and passive illustrations to be used during the auction process.

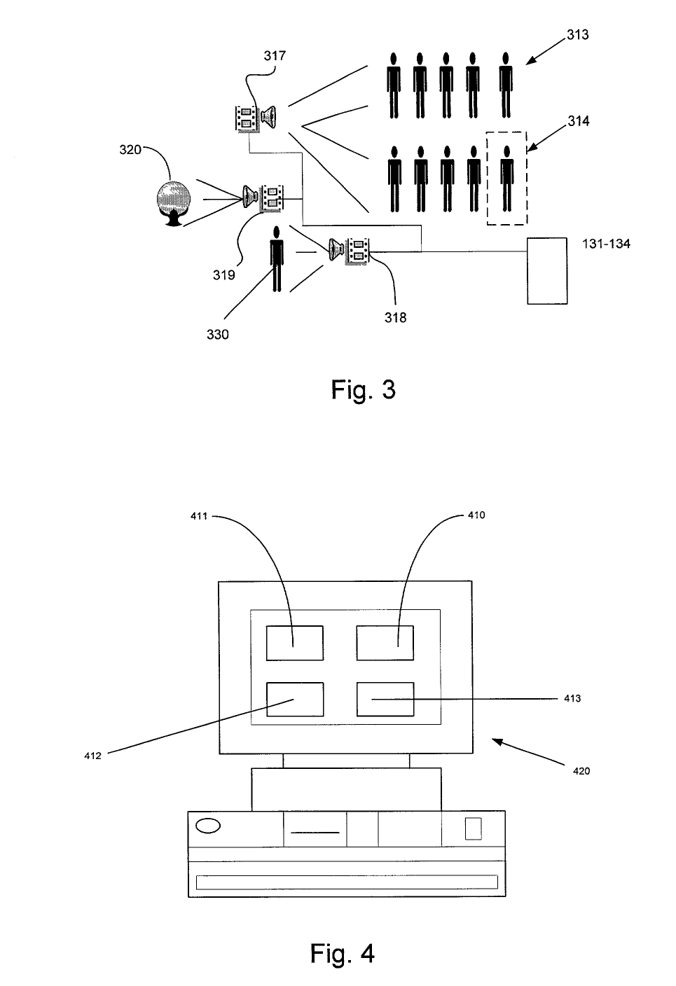

Referring now to FIG. 3, a single auction house 141-144 can utilize one or more multimedia devices 317-319 in order to capture video images. In one embodiment, multiple multimedia devices 317-319 can be utilized simultaneously. For example, a first multimedia device 317 can be used to record and transmit an image of the bidding crowd 313 present at a live auction. A second multimedia device 318 can be used to record and transmit a video image of an auctioneer 330 conducting the live auction. A third multimedia device 319 can be used to record and transmit an image of a piece of property 320 currently being auctioned by the auctioneer 330. Other multimedia devices 120-123 can be used to record and transmit any other image that would facilitate the live auction. Images recorded on the multimedia devices 120-123 317-319 can be transmitted to the auction house processing system 131-134. The auction house processing system 131-134 can coordinate the inputs from the multimedia devices 120-123 317-319 with other information related to the auction and transmit all related information to a live auction host 150.

Other information related to an auction can include, for example, descriptions of a piece of property being auctioned, information relating to the auction house 141 -144 conducting the auction, the amount of bids being processed, information describing an auctioneer 330, and any other information useful to facilitate a live auction.

Referring now to FIG. 4, a user interface 421 can be presented on an electronic display device 420 included as part of a client computer or other network access device 201-206. The user interface 421 can include multiple areas 410-413 defined on the display device 420. In one embodiment, a user participating in a live auction can designate the content of each display area 410-413. For example, a user accessing the live auction host 150 with a personal computer network access device 201 can view multiple windows occupying various areas 410-413 on a CRT being used as a display device 420. Other display types can include, for example, a flat panel display, TFT display, or an LED display. Each window occupying a specific geographic area 410-413 of the display device 420, can display a separate image. A first window may display an image of the auctioneer 330, a second window may display an image of the bidding crowd 313 and a third image may display an image of a piece of property 320 being auctioned.

Still another display area can include a form or other user interactive mechanism operable with the live auction host 150 to allow a bidder to participate in the live auction. A bidder can fill out the form and submit a bid to the live auction host 150. The live auction host 150 can forward information contained in a bid to the auctioneer 330 via the auction house processing system 131-134.

A bid submitted via the user interface can be presented to the auctioneer 330 in real time such that the auctioneer 330 can allow the bid to compete directly with bids being proffered from the bidding crowd 313.

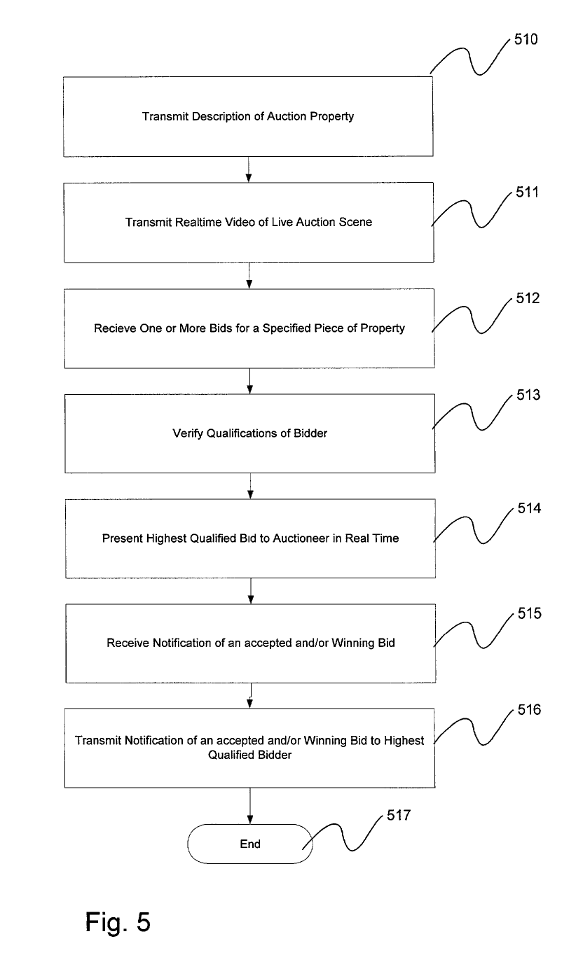

Referring now to FIG. 5, a method of utilizing a live auction host to provide real time access to a live auction can include transmitting a description of property that will be auctioned 510. The description of the auctioned property can also include a graphic image or a video clip illustrating the property. The description, image and/or video of the property to be auctioned can be made available for a period of time prior to the auction. This prior transmission can be used to prepare a potential bidder for an upcoming auction. A real time video of the live auction scene can also be transmitted 511. Primarily the real time video will be transmitted during the actual auction by the auctioneer 330. However, in one embodiment, a real time video of the auction scene can also be transmitted during a preview time wherein the inspection of a piece of property to be auctioned by potential bidders and appraisers can be viewed by potential online bidders. Another embodiment allows for an archive of auction proceedings. The archive can allow past auctions viewing of the auction, including the bids, the video of the bidding crowd, the auctioneer, and any other recorded data.

During the live auction, the live auction host can receive one or more bids for a specified piece of property being auctioned 512. The bids received by the live auction host are submitted via a network access device 201-207. The live auction host can also verify the qualifications of the bidder 513 to insure that the bid is made in good faith. Qualification can include verification of available funds and contractual agreement to consummate a sale entered into via an auction bid. The highest qualified bid can be presented to the auctioneer in real time 514. Presentation of the highest qualified bid to the auctioneer can be accomplished with a display provided to the auctioneer or via a surrogate bidder present in the bidding crowd 313. In one embodiment, the auctioneer uses a network access device 201-207 to communicate with the live auction host 150. The auctioneer 330 can use the network access device 201-207 to indicate an accepted bid and/or a winning bid 515. In an alternate embodiment, a surrogate bidder 314 present in the bidding crowd 313 notifies the live auction host of a highest and/or winning bid 515. The live auction host 150 can automatically transmit notification of an accepted and/or winning bid to a highest qualified bidder 516.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

The invention may also be advantageously implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Computers 201-206, 231-232, 241-244 in a live auction system may be connected to each other by one or more network interconnection technologies. For example dial-up lines, token-ring and/or Ethernet networks 210, 240, Ti lines, asynchronous transfer mode links, wireless links and integrated service digital network (ISDN) connections may all be combined in the network 200. Other packet network and point-to-point interconnection technologies may also be used. Additionally, the functions associated with separate processing and database servers in the host 250 may be integrated into a single server system or may be partitioned among servers and database systems that are distributed over a wide geographic area.

A number of embodiments of the present invention have been described. Nevertheless, it will be understood that various modifications may be made without departing from the spirit and scope of the invention. For example, client computers 201-206 can comprise a personal computer executing an operating system such as Microsoft Windows™, UniX™, or Apple Mac OS™, as well as software applications, such as a web browser. Client computers 201-206 can also be terminal devices, a palm-type computer WEB access device that adhere to a point-to-point or network communication protocol such as the Internet protocol. Other examples can include TV WEB browsers, terminals, and wireless access devices (such as a 3-Com Palm organizer). A client computer may include a processor, RAM and/or ROM memory, a display capability, an input device and hard disk or other relatively permanent storage. Accordingly, other embodiments are within the scope of the following claims.

What is claimed is:

1. A computer-implemented method for providing online participation in a live auction, the method comprising:
transmitting over a computer communications network a description of a piece of property to be auctioned and a real time video image of a scene depicting a live auction of the property;
receiving a bid for the property via the computer communications network;
presenting the bid to an auctioneer; and
transmitting a notification of a winning bid.

2. The method of claim 1 additionally comprising transmitting a video image of the property.

3. The method of claim 1 additionally comprising calculating a highest bid received via the computer communications network and presenting the highest bid to an auctioneer involved in auctioning the property.

4. The method of claim 3 wherein the presentation of the highest bid to the auctioneer is accomplished with an electronic display.

5. The method of claim 3 wherein the presentation of the highest bid to the auctioneer is accomplished via a surrogate bidder.

6. The method of claim 1 additionally comprising capturing real time video images of multiple scenes depicting the live auction; and
making the multiple real time images available via the computer communications network.

7. The method of claim 1 additionally comprising the step of verifying the financial credibility of a bidder submitting a bid.

8. The method of claim 1 additionally comprising:
tracking multiple auctions with corresponding images and bids;
processing a bid is received for a particular property; and
transmitting the bid to a corresponding auction house server.

9. A computer system for providing online participation in a live auction, the system comprising:
a computer server accessible via a computer communications network, wherein the server comprises a memory and a processor;
a multimedia device capable of inputting scenes from the live auction into the server; and
executable software residing in the server memory wherein the software is operative with the processor to:
cause a scene input by the multimedia device to be transmitted over the communications network;
receive a bid via the communications network; and
transmit a notification relating a winning bid via the communications network.

10. The computer system of claim 9 wherein the software is executable on demand via the network access device.

11. The computer system of claim 9 wherein the network access device comprises a computer.

12. The computer system of claim 9 wherein the computer communication network conforms to the transmission control protocol/internet protocol.

13. The computer system of claim 9 wherein the computer communication network comprises an intranet.

14. The computer system of claim 9 additionally comprising a WEB interface for accessing the executable software stored on the server storage medium.

15. A computer system for managing online participation in multiple live auctions, the system comprising:
an auction host computer server accessible via a computer communications network, wherein the auction host server comprises a memory and a processor;
an auction house computer server for communicating with the auction host computer server via the communications network;
a multimedia device capable of inputting a scene from a live auction into the auction house computer server; and
executable software residing in the auction host computer server memory, wherein the software is operative with the processor to:
cause a scene input by the multimedia device to be transmitted over the communications network;
receive a bid for an auctioned property via the communications network; and
transmit the bid to the auction house server.

16. The computer system of claim 15 wherein the multimedia device is a video camera.

17. The computer system of claim 15 wherein the software is additionally operative with the processor to transmit a notification of a winning bid.

18. The computer system of claim 15 wherein the software is additionally operative with the auction host computer server to calculate a highest bid received for an auctioned property and transmit only a currently highest bid.

19. The computer system of claim 15 additionally comprising a display screen for displaying bids received for a particular property to a bidding crowd involved in the auction of that property.

20. Computer executable program code residing on a computer-readable medium, the program code comprising instructions for causing the computer to:
transmit a description of a piece of property to be auctioned and a real time video image of a scene depicting a live auction of the property over a computer communications network;
receive a bid for the property via the computer communications network; and
transmit a notification of a winning bid via the computer communications network.

21. The computer executable program of claim 20 wherein the program code additionally causes the computer to:
track multiple auctions with corresponding images and bids;
calculate a highest bid received for a particular property; and
transmit the highest bid to a corresponding auction house server.

22. A user interface for participating in a live auction, the interface comprising:
an electronic display connected to a network access device and multiple display areas defined on the display, wherein various scenes depicting a live auction are displayed in the various areas.

23. A computer data signal embodied in a digital data stream, wherein the computer data signal is generated by a method comprising the steps of:
transmitting over a computer communications network a description of a piece of property to be auctioned and a real time video image of a scene depicting a live auction of the property;
receiving a bid for the property via the computer communications network; and
transmitting a notification of a winning bid via the computer communications network.

23. The computer data signal of claim 23 wherein the data signal is generated by a method additionally comprising the steps of:
tracking multiple auctions with corresponding images and bids;
calculating a highest bid received for a particular property; and
transmitting the highest bid to a corresponding auction house server.

24. A computer data signal as in claim 23 wherein the signal generated adheres to the transmission control protocol/internet protocol.
